(19) United States
(12) Patent Application Publication
(10) Pub. No.: US 2026/0367638 A1
(43) Pub. Date: Nov. 19, 2026

(54) METHOD OF GENERATING OVERTAKING TRAJECTORY OF MOBILE ROBOT AND MOBILE ROBOT CAPABLE OF OVERTAKING USING THE SAME

(71) Applicant: Twinny Co., Ltd., Daejeon (KR)

(72) Inventors: Yun Jeong KIM, Sejong (KR); Yong Jin BYOEN, Daejeon (KR); Min Gyung JANG, Daejeon (KR)

(21) Appl. No.: 19/514,998

(22) PCT Filed: Aug. 29, 2024
(86) PCT No.: PCT/KR2024/012956

§ 371 Date: Feb. 27, 2026

(30) Foreign Application Priority Data
Sep. 7, 2023 (KR) 10-2023-0119164

(51) Int. Cl. G05D 1/622; G05D 1/243

(52) U.S. Cl. CPC G05D 1/622; G05D 1/243

(57) ABSTRACT

A method of generating an overtaking trajectory of a mobile robot which allows the mobile robot to move along a set path as much as possible and in which the mobile robot can return to the set path with minimal avoidance when movement of the mobile robot is impossible due to an obstacle, etc. during the movement of the mobile robot, and a mobile robot capable of overtaking using the same.

### TECHNICAL FIELD

An embodiment of the present invention relates to a method of moving a robot, and more particularly, to a method of generating an overtaking trajectory along which a robot can move while avoiding an obstacle, and a mobile robot using the same.

### BACKGROUND ART

Most autonomous robots basically include a function to autonomously move to their destination points within a given environment map, and estimate their locations on the map in real time, plan a path to their destination point, and then move along the planned path through motion control. When an obstacle is present on a movement path planned by the robot, the robot generates a path to avoid the obstacle.

As an example of the conventional path planning method through which it is possible to avoid an obstacle, there is a method in which an obstacle avoidance algorithm of FIG. 1 determines whether an obstacle can be avoided by increasing a turning angle of a mobile robot in one direction when the obstacle is detected while traveling, and when it is impossible for the mobile robot to avoid the obstacle until the mobile robot rotates to a predetermined maximum angle, allows the mobile robot to rotate at a random angle and perform overtaking when traveling is possible and allows the mobile robot to search for a path along which avoidance is possible using obstacle information stored during random rotation of the mobile robot when traveling is impossible, thereby allowing a mobile robot to travel while avoiding obstacles. In this path planning method, since a path that is determined to be optimal for the surrounding situation, such as the presence and absence and location of an obstacle, is selected in an overtaking method of the mobile robot, even when the mobile robot moves from the same starting point to a destination point, the same path is rarely formed.

This type of overtaking method is suitable for application to a path that a mobile robot takes for the first time, but it requires precise sensing of the surrounding environment and requires much data processing, and thus has a problem of being inefficient when applied to robots that move in a set space or move between a small number of points. Simple examples of moving in the set space or moving between a small number of points include transporting goods in a warehouse or moving between multiple manufacturing process devices in a factory. In this situation, since obstacles and devices are determined to some extent and the robot often moves along a specific movement line, there is no need for excessive investment in hardware or software for processing such as performing scanning while the robot rotates in a random direction as in the conventional method.

In addition to this aspect of resource waste, when the mobile robot adopts a random path every time in a situation where there are people in a warehouse or factory, it is difficult for people to predict a movement path of the mobile robot, and thus there is a problem that an accident such as a collision between a person and the mobile robot occurs.

### DISCLOSURE OF INVENTION

### Technical Problem

The present invention is directed to solving the problems described above, and the problem to be solved by the present invention is to provide a method of generating an overtaking trajectory of a mobile robot which allows the mobile robot to move along a set path as much as possible and in which the mobile robot can return to the set path with minimal avoidance when movement of the mobile robot is impossible due to an obstacle, etc. during the movement of the mobile robot, and a mobile robot capable of overtaking using the same.

Problems of the present invention are not limited to the problems mentioned above, and other problems that are not mentioned will be clearly understood by those skilled in the art from the description below.

### Solution to Problem

A method of generating an overtaking trajectory of a mobile robot according to the present invention is a method in which, between a main travel line, which includes a straight line, bent straight line, or curve having a starting point and a destination point at both ends thereof, and an overtaking line formed parallel to the main travel line, when a mobile robot moves from the starting point to the destination point along the main travel line but an obstacle is detected during movement of the mobile robot, the mobile robot moves to the overtaking line and then returns to the main travel line, and the method includes a main travel line traveling operation in which a mobile robot travels along the main travel line, a first forward obstacle detection operation of detecting whether an obstacle that has a possibility of collision with the mobile robot is present in front of the mobile robot on the main travel line and continuing front obstacle monitoring until a forward waiting time elapses while the mobile robot is stopped when the obstacle is present, an overtaking path generation operation of generating an overtaking path along which the mobile robot returns to the main travel line via the overtaking line when the obstacle is present in front of the mobile robot on the main travel line while the forward waiting time has ended, a second forward obstacle detection operation of detecting whether an obstacle is present on a path along which the mobile robot returns to the main travel line, a main travel line forward movement and return operation in which the mobile robot moves forward and returns to the main travel line when no obstacle is present in the second forward obstacle detection operation, and a main travel line backward movement and return operation in which the mobile robot moves backward to a starting point of the first movement trajectory and returns to the main travel line when the obstacle is present in the second forward obstacle detection operation.

### Advantageous Effects of Invention

According to a method of generating an overtaking trajectory of a mobile robot and a mobile robot capable of overtaking using the same according to the present invention, the mobile robot can move with minimum avoidance on a path of which a starting point and a destination point are set.

In addition, since the mobile robot moves or an overtaking path of the mobile robot is derived after a predetermined waiting time, such as the forward waiting time, it is possible to effectively respond to a temporary obstacle.

The effects of the present invention are not limited to the effects mentioned above, and other effects that are not mentioned will be clearly understood by those skilled in the art from the description of the claims.

### BRIEF DESCRIPTION OF DRAWINGS

FIG. 1 is a diagram illustrating a conventional path planning method that enables avoidance of an obstacle.

FIG. 2 is a perspective view of a mobile robot capable of overtaking according to the present invention.

FIG. 3 is a configuration diagram of the mobile robot capable of overtaking according to the present invention.

FIG. 4 is a diagram illustrating a workspace and a traveling form of the mobile robot, in which the method of generating an overtaking trajectory of a mobile robot and the mobile robot capable of overtaking according to the present invention may be utilized.

FIG. 5 is a diagram illustrating a case where an obstacle is detected in front of a mobile robot on a main travel line.

FIG. 6 is a diagram illustrating an overtaking path set in the present invention.

FIG. 7 is a diagram illustrating a situation where no collision of a mobile robot with an obstacle occurs along a second movement trajectory and third movement trajectory and the mobile robot returns to a main travel line.

FIG. 8 is a diagram illustrating a case where a mobile robot moves backward by a maximum backward search distance and an overtaking path is generated.

FIG. 9 is a diagram illustrating a case where a collision with an obstacle is expected while a mobile robot is moving on a first movement trajectory.

FIG. 10 is a diagram illustrating a case where two mobile robots capable of overtaking according to the present invention move on the same main travel line.

FIG. 11 is a diagram illustrating a case where collision and avoidance of two mobile robots capable of overtaking according to the present invention occur.

FIG. 12 is a configuration diagram of a module assembly that generates an overtaking trajectory of a mobile robot on a PC.

FIGS. 13 to 15 are flowcharts of a method of generating an overtaking trajectory of a mobile robot according to the present invention.

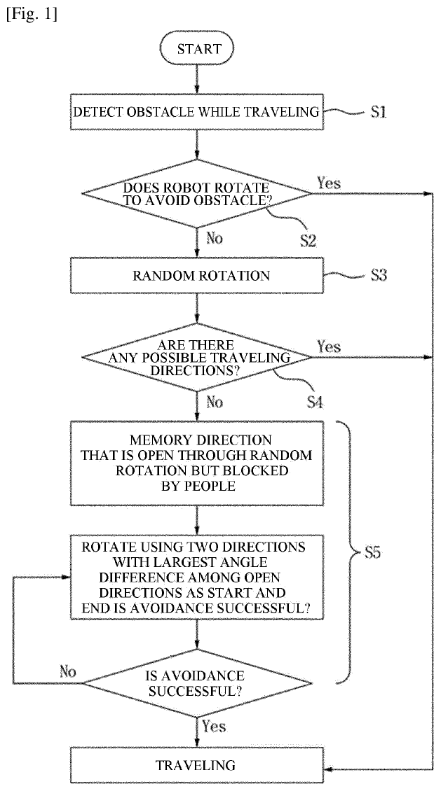

### MODE FOR THE INVENTION

Hereinafter, a method of generating an overtaking trajectory of a mobile robot according to the present invention and a mobile robot capable of overtaking using the same will be described in detail with reference to the accompanying drawings.

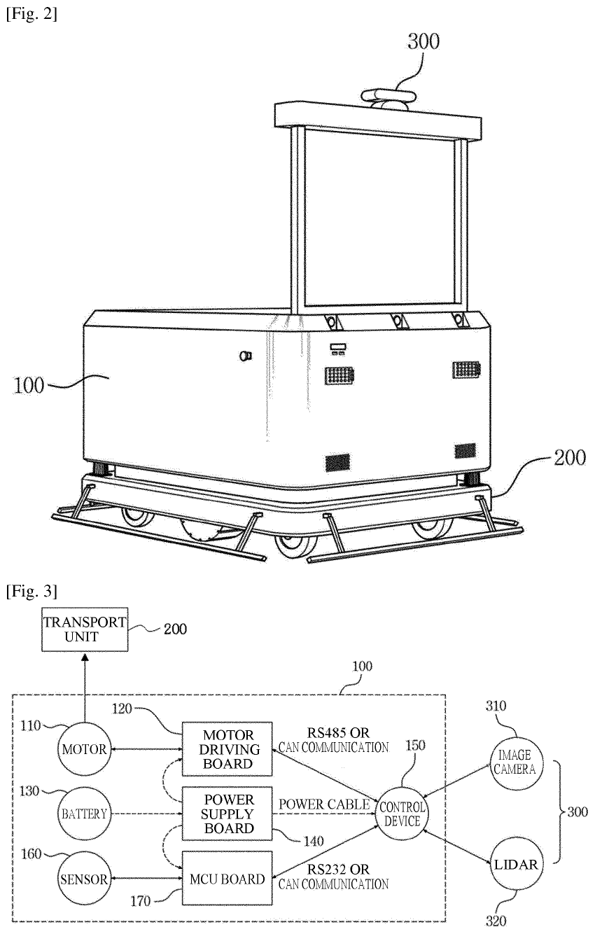

FIG. 2 is a perspective view of a mobile robot capable of overtaking according to the present invention, and FIG. 3 is a configuration diagram of the mobile robot. The mobile robot capable of overtaking according to the present invention includes a main body 100, a transport unit 200 that moves the main body 100, and a sensor unit 300 provided in the main body 100. When the sensor unit 300 detects a set target, such as a carrier, in a three-dimensional space and generates sensing data, the main body 100 processes the sensing data to detect a target, and the transport unit 200 moves the main body 100 according to a control command.

The main body 100 is a component that detects a location of an obstacle in the space in which the mobile robot capable of overtaking according to the present invention moves (hereinafter referred to as “workspace”; examples include the inside of a logistics warehouse, the inside of a factory, etc.) from the sensing data collected by the sensor unit 300 and generates an overtaking path.

The transport unit 200 is a component including wheels or endless tracks and transports the main body 100 under the control of the main body 100.

The sensor unit 300 is formed of an image camera 310 that photographs images or a LiDAR 320, and is a component that generates obstacle images or LiDAR sensing data (hereinafter referred to as “sensing data”) and transmits the obstacle images or LiDAR sensing data to the main body 100. The sensor unit 300 may set a predetermined area in front of the mobile robot as a region of interest (ROI) and collect sensing data only within the ROI.

The main body 100 may include a motor 110 that generates motion necessary for the movement of the robot with respect to transport elements such as wheels or endless tracks, a motor driving board 120 that controls the motor 110, a battery 130, a power supply board 140 that controls the battery, and a control device 150 that receives sensing data from the sensor unit 300, sets a path, and generates operation commands to control the motor driving board 120 and the power supply board 140. The control device and its components may include one or more processor/microprocessor(s) coupled with a computer-readable recording medium that stores computer-readable code/algorithm/software. By way of example, the control device 150 may be a microcomputer or a personal computer (PC).

The main body 100 may further include a sensor 160 such as an infrared sensor or an ultrasonic sensor, and a micro controller unit (MCU) board 170 that collects data sensed by the sensor 160. Data and control commands may be transmitted and received between the control device 150, the motor driving board 120, and the MCU board 170 through RS232, CAN communication, etc.

The control device 150 processes the sensed sensing data to detect a target, and this target detection may be performed using firmware or software. In the present invention, the implementation of such target detection is approached in terms of the concept of a module (which may be implemented in hardware or software, but the technical idea is the same, and thus the hardware and software implementations of the module are not distinguished) without distinguishing between firmware and software.

Prior to the description of the detailed components, an environment assumed by the present invention and a key problem-solving method will be described first.

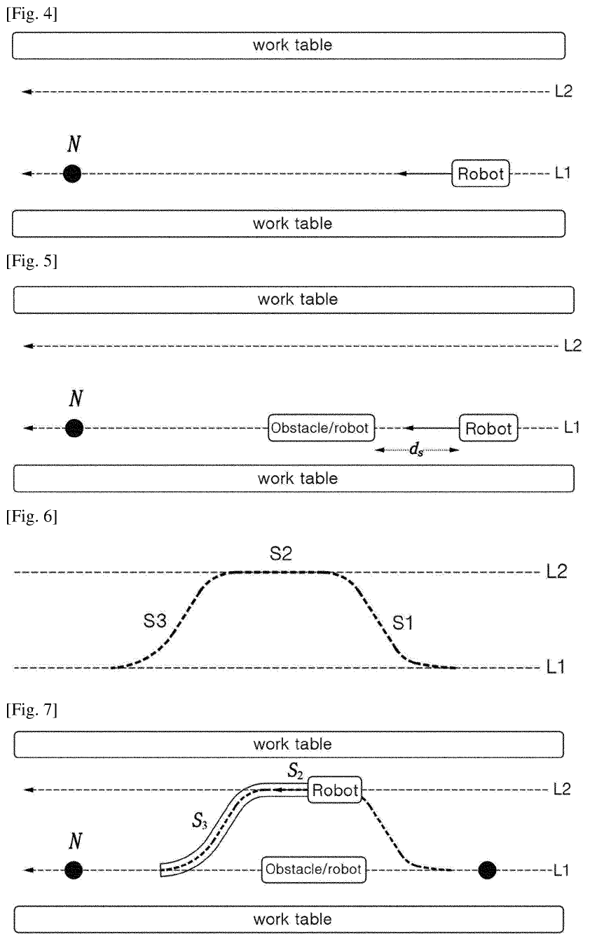

FIG. 4 illustrates a workspace and a traveling form of the mobile robot, in which the method of generating an overtaking trajectory of a mobile robot and the mobile robot capable of overtaking according to the present invention may be utilized. In the present invention, it is assumed that a main travel line L1 including a straight line, a bent straight line, or a curve having a departure point and destination point at both ends thereof and an overtaking line L2 formed parallel to the main travel line L1, and a basic traveling principle is that a mobile robot moves from the departure point to the destination point along the main travel line L1, but when an obstacle is detected during the movement of the mobile robot, the mobile robot moves to the overtaking line L2, and then returns to the main travel line L1. That is, the mobile robot prefers to travel along the main travel line L1, moves to the overtaking line L2 and travels thereon only when it is impossible to move on the main line L1, and when it becomes possible to travel on the main travel line L1, the mobile robot returns to the main travel line L1.

Therefore, if no obstacle is detected on the main travel line L1, the mobile robot may arrive at the destination point along the main travel line L1 as illustrated in FIG. 4.

For simplicity of illustration, the main travel line L1 and the overtaking line L2 are illustrated as straight lines in FIG. 4 and the subsequent drawings, but the technical idea of the present invention is established even if the main travel line L1 is a bent straight line or curve. When the main travel line L1 is a bent straight line or curve, the overtaking line L2 will be a bent straight line or curve that is spaced a certain distance from the main travel line L1.

FIG. 5 is a diagram illustrating a case where an obstacle is detected in front of a mobile robot on a main travel line. In the present invention, when an obstacle is detected like this, rather than immediately determining whether overtaking is possible, the mobile robot stops for a predetermined forward waiting time and monitors whether the obstacle disappears. This is because, when the obstacle is a person in the work space, the person may move along his or her work path, or the person may detect the mobile robot and deviate from his or her location on the work path. The reason why such obstacle avoidance by a person is possible is that a person may predict a path of the mobile robot, as described previously in the [Background Art]. Here, the paths of the mobile robot that can be predicted by a person are the main travel line L1 and the overtaking path that will be described below.

The maximum distance to detect an obstacle on the main travel line L1 is referred to as a forward detection distance ds. When an obstacle is detected within the forward detection distance ds while the mobile robot moves forward on the main travel line L1, the mobile robot stops until the forward waiting time elapses. When the obstacle does not disappear within the forward detection distance ds even after the forward waiting time, the mobile robot considers generating an overtaking path.

When an obstacle is detected even at the time when the forward waiting time has ended, the mobile robot determines whether traveling is possible after moving to the overtaking line L2. This is because an obstacle may also be present on the overtaking line L2, making it impossible to create an overtaking path. This is because an obstacle may also be present on the overtaking line L2, and thus generating an overtaking path may not be possible. In relation to determining the possibility of overtaking, it is necessary to know about an overtaking path set in the present invention. FIG. 6 is a diagram illustrating an overtaking path set in the present invention, and the overtaking path includes a first movement trajectory S1 along which the mobile robot moves from the main travel line L1 to the overtaking line L2, a second movement trajectory S2 along which the mobile robot moves on the overtaking line L2, and a third movement trajectory S3 along which the mobile robot returns from the overtaking line L2 to the main travel line L1. Here, a primary determination of whether overtaking is possible is made on the first movement trajectory S1 and the second movement trajectory S2. This is because in most cases, it is possible to avoid an obstacle on the main travel line L1 only when the mobile robot has moved a certain distance after moving to the overtaking trajectory. Determination of whether overtaking is possible may be made by the sensor unit 300 transmitting sensing data obtained by sensing the first movement trajectory S1 and the second movement trajectory S2 to the control device 150 of the main body 100 and the control device 150 performing a predetermined determination algorithm.

When overtaking is possible because no obstacles are present on the first movement trajectory S1 and the second movement trajectory S2, the mobile robot moves to a starting point of the second movement trajectory S2, which is an end point of the first movement trajectory S1, and determines whether returning to the main travel line L1 is possible, that is, whether a collision with an obstacle will occur on the second movement trajectory S2 and the third movement trajectory S3. When it is determined that a collision with the obstacle will not occur, the mobile robot travels on the second movement trajectory S2 and the third movement trajectory S3 as illustrated in FIG. 7 and returns to the main travel line L1. When it is expected that a collision with the obstacle will occur on the second movement trajectory S2 or the third movement trajectory S3, similar to the forward waiting described above, the mobile robot stops for a predetermined lane change waiting time to determine whether the obstacle disappears and returns to the main travel line L1 when the obstacle disappears.

When an obstacle is present on the second movement trajectory S2 and third movement trajectory S3 even after the lane change waiting time has ended, the mobile robot moves backward along the first movement trajectory S1 and returns to the main travel line L1 as a kind of initialization concept. When an obstacle is present on the backward movement return trajectory, the mobile robot stops for a predetermined backward waiting time to determine whether the obstacle disappears, and when the obstacle disappears, the mobile robot moves to the starting point of the first movement trajectory S1. When the obstacle does not disappear, the mobile robot is in a situation where the mobile robot is unable to move forward or backward on the overtaking line L2, and thus waits until returning to the main travel line L1 via the second movement trajectory S2, the third movement trajectory S3, or the first movement trajectory S1 becomes possible.

The problem is that an obstacle is present in front of the mobile robot on the main travel line L1 and overtaking of the mobile robot along the first movement trajectory S1 and the second movement trajectory S2 is impossible. In this case, the mobile robot becomes unable to make any forward movement. In this case, the mobile robot waits for the lane change waiting time and determines whether overtaking along the first movement trajectory S1 and the second movement trajectory S2 becomes possible. When it is determined that the overtaking becomes possible, the mobile robot moves to the starting point of the second movement trajectory S2 in the same manner as described above, and returns to the main travel line L1 through the second movement trajectory S2 and the third movement trajectory S3. When the overtaking is not possible until the lane change waiting time has ended, the mobile robot is unable to generate an advancement path on either of the main travel line L1 and the overtaking line L2, and thus the mobile robot should search for other paths where the mobile robot can advance. The method of searching for other paths adopted in the present invention is trajectory search by backward movement traveling.

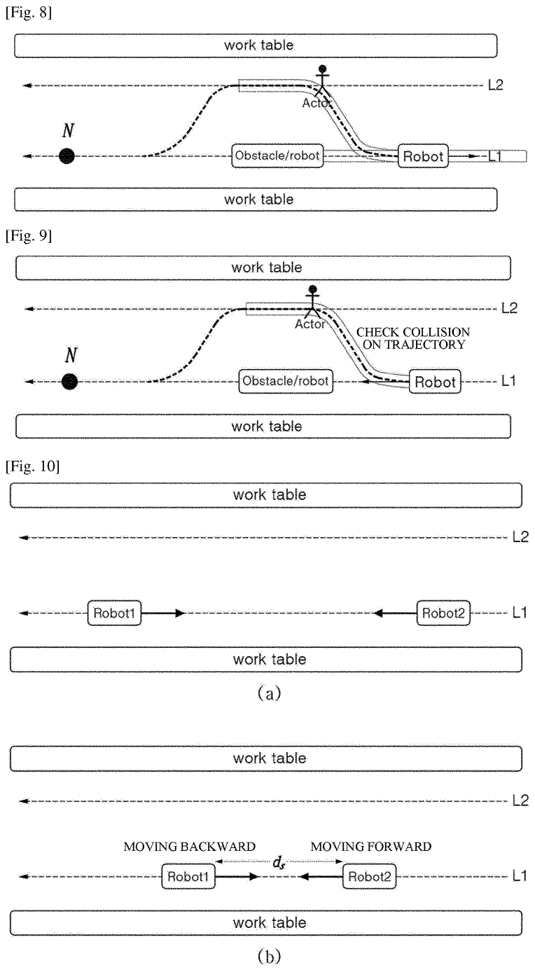

When the advancement path is not generated on either of the main travel line L1 and the overtaking line L2 in a forward direction, the mobile robot moves backward on the line L1 by a predetermined maximum backward search distance as illustrated in FIG. 8 and determines whether a path can be generated on the main travel line L1 or the overtaking line L2. Determining the possibility of generating a path on the main travel line L1 means that the mobile robot monitors an area ahead of the mobile robot as much as a distance that the mobile robot moves backward plus its forward detection distance ds while the mobile robot is moving backward, and determines whether it is possible to move by the distance from a point where the mobile robot starts moving backward to the forward detection distance ds, that is, whether no obstacles are present. This change in detection range can be achieved by adjusting an image photographing range or LiDAR scanning range (in most general traveling, photographing data or LiDAR scan energy should be kept low, and an amount of computation increases and forward traveling or overtaking becomes impossible when an obstacle that is located too far away is considered, and thus the forward detection distance ds should be limited to within a certain value).

Processing for a case where forward movement is not possible on the main travel line L1 but an overtaking path is generated is the same as the case where overtaking driving is possible because no obstacles are present on the first movement trajectory S1 and the second movement trajectory S2 described above. That is, the mobile robot checks whether it is possible to move from a point on the main travel line L1 where the overtaking path is generated to the first movement trajectory S1 and the second movement trajectory S2. When the movement to the first movement trajectory S1 and the second movement trajectory S2 is possible, the mobile robot returns to the main travel line L1 via the third movement trajectory S3. Processing for a case where a collision of the mobile robot with an obstacle, etc. is expected during the movement of the mobile robot may also be performed in the same manner. In this case, it may be better to locate the starting point of the first movement trajectory S1 a little further backward than the point on the main travel line L1 where the overtaking path is generated. That is, overtaking needs to be started after a collision check is performed up to a point further backward by an additional backward movement distance even when an overtaking path can be generated at a certain point up to the maximum backward search distance. When an overtaking path is not generated while the mobile robot is moving the maximum backward search distance, the mobile robot has no possible traveling path, and thus the mobile robot waits at the point of the maximum backward search distance and determines whether a forward traveling path or an overtaking path is generated (waits indefinitely).

Processing for a case where a collision of the mobile robot with an obstacle is expected while changing a travel line may be necessary. For example, the processing corresponds to processing for a case where it was determined that the movement of the mobile robot to the first movement trajectory S1 and the second movement trajectory S2 was possible when generating an overtaking path, but a collision of the mobile robot with an obstacle is expected while the mobile robot is actually moving. This situation may be due to the sudden appearance of an obstacle, or may be due to a discrepancy between the generated overtaking path and a location of the actually moving mobile robot (such as the starting point of the first movement trajectory S1). FIG. 9 is a diagram illustrating a case where a collision of the mobile robot with an obstacle is expected while the mobile robot is moving on the first movement trajectory. When the collision is expected, the mobile robot stops and waits for a predetermined collision avoidance time to determine whether the collision situation is resolved. That is, when it is determined that no collision of the mobile robot with the obstacle is expected on the first movement trajectory S1 and the second movement trajectory S2 up to the collision avoidance time, the mobile robot moves to the starting point of the second movement trajectory S2 and then determines the possibility of collision with the obstacle on the second movement trajectory S2 and the third movement trajectory S3 described above, and goes through the same procedure. When the collision with the obstacle is expected on the first movement trajectory S1 and the second movement trajectory S2 before the collision avoidance time has ended, the mobile robot moves backward along the first movement trajectory S1 and returns to the main travel line L1, and the subsequent processing is the same as described above. In this case, when a collision with an obstacle is expected again during the backward movement process, the mobile robot is unable to move forward or backward on the first movement trajectory S1, and thus stops and waits to determine whether a travel path is generated in a forward or backward direction thereof. That is, when no collision with an obstacle is expected while the mobile robot moves forward to the first movement trajectory S1 and the second movement trajectory S2, or when no collision with an obstacle is expected while the mobile robot moves backward to the first movement trajectory S1, the mobile robot advances to the trajectory where no collision with an obstacle is expected. When the mobile robot becomes able to move forward and backward at the same time, the mobile robot preferentially adopts forward movement along the first movement trajectory S1 and the second movement trajectory S2.

Depending on the settings of the forward waiting time and backward waiting time, a plurality of mobile robots capable of overtaking according to the present invention may travel more effectively. FIG. 10 is a diagram illustrating a case where two mobile robots capable of overtaking according to the present invention move on the same main travel line, which is a situation that often occurs in automated factories, and each mobile robot perceives the other mobile robot as an obstacle.

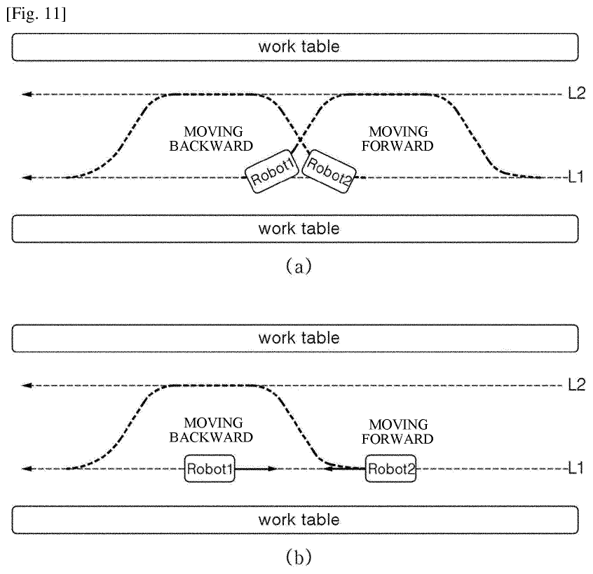

The direction in which the mobile robot moves forward on the main travel line L1 is a direction from the starting point to the destination point, and thus a situation in which two mobile robots face each other corresponds to a situation in which a mobile robot 1 located ahead moves backward and a mobile robot 2 located behind moves forward. Here, when the forward waiting time and the backward waiting time are the same, the mobile robots 1 and 2 wait for the same backward waiting time or forward waiting time before moving. Therefore, even when the mobile robots 1 and 2 move by forming an overtaking path, the mobile robots 1 and 2 collide with each other again at a midpoint as illustrated in FIG. 11(a), and this situation is repeated. On the other hand, when the forward waiting time and the backward waiting time are set differently, for example, when the forward waiting time is shorter than the backward waiting time, as illustrated in FIG. 11(b), since the mobile robot 2 moves along an overtaking path first, a collision thereof with the mobile robot 1 may not occur.

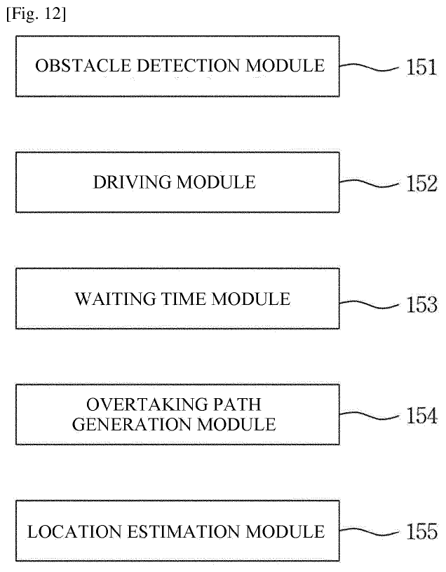

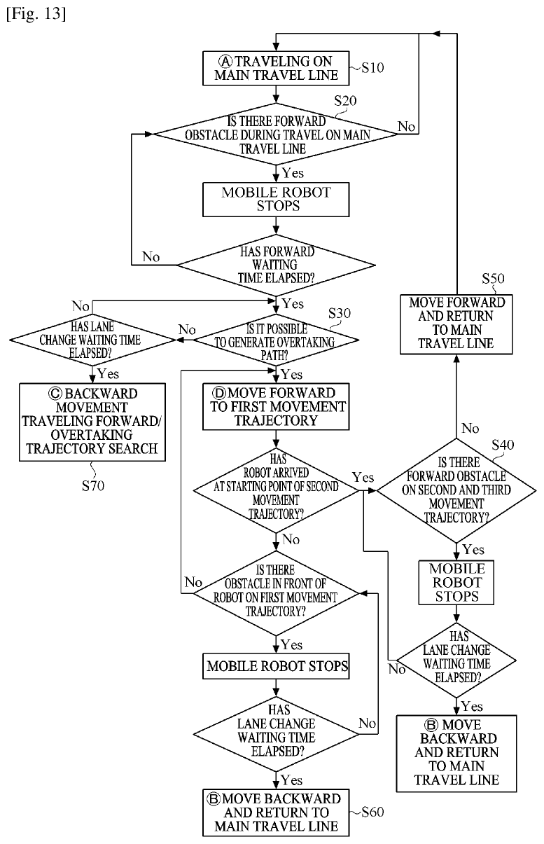

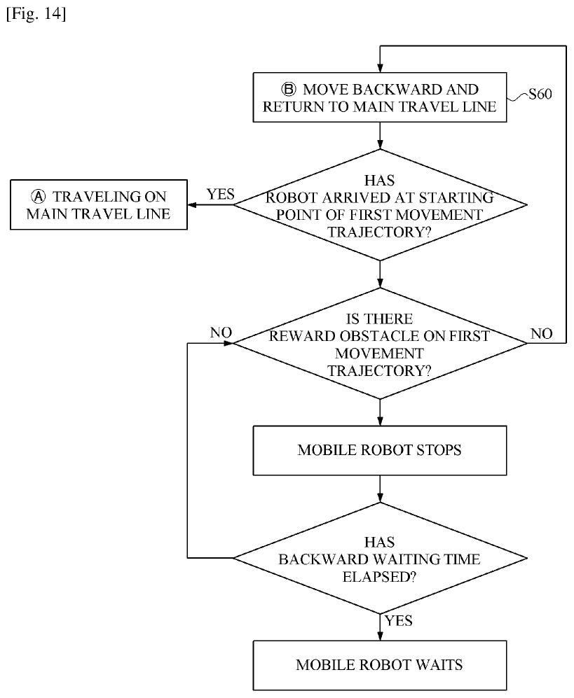

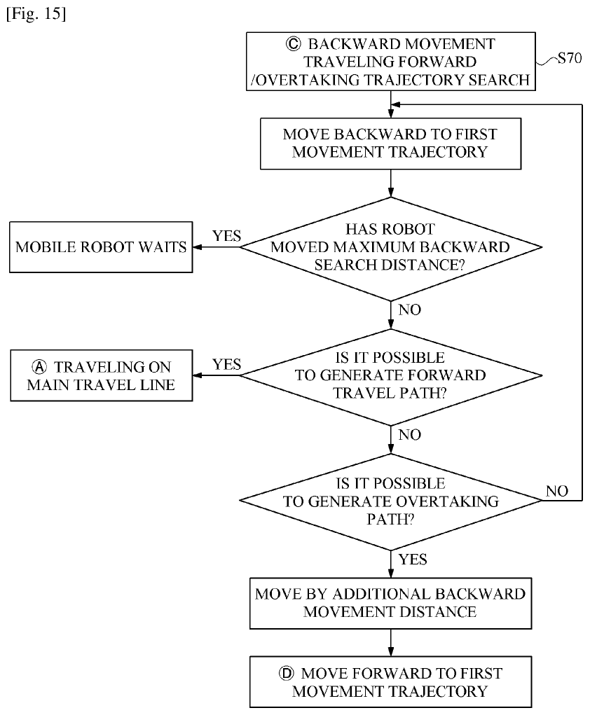

FIG. 12 is a configuration diagram of a module assembly that generates an overtaking trajectory of a mobile robot on a PC. FIGS. 13 to 15 are flowcharts of a method of estimating an attitude performed in each module and are also flowcharts of a method of generating an overtaking trajectory of a mobile robot according to the present invention.

In the present invention, the control device 150 includes an obstacle detection module 151, a driving module 152, a waiting time module 153, an overtaking path generation module 154, and a location estimation module 155 and performs detection of an obstacle present on a path in the forward direction and backward direction, movement and stopping of the mobile robot, setting of forward waiting time/backward waiting time/lane change waiting time and determination of whether forward waiting time/backward waiting time/lane change waiting time has elapsed, generation of an overtaking path, and estimation of a location of a mobile robot on an overtaking path. That is, respective operations of the method of generating an overtaking trajectory of a mobile robot according to the present invention are performed by the modules of the control device 150, and each module may be involved in a plurality of operations in the method of generating an overtaking trajectory for a mobile robot according to the present invention.

The obstacle detection module 151 is a component that detects an obstacle present in front of the mobile robot on the main travel line, an obstacle present in front of the mobile robot on the first, second, and third movement trajectories, and an obstacle present to the rear of the mobile robot on the first movement trajectory, and the driving module 152 is a component that generates commands to cause the mobile robot to travel and stop on the main travel line and first, second, and third movement trajectories. The waiting time module 153 sets the forward waiting time, the backward waiting time, and the lane change waiting time and determines whether the waiting time has elapsed to determine whether to generate an overtaking path and perform a first movement trajectory backward movement return, etc. The overtaking path generation module 154 is a component that generates an overtaking path including the first movement trajectory S1, the second movement trajectory S2, and the third movement trajectory S3. The location estimation module 155 is a component that estimates a location of the mobile robot on the main travel line L1, the overtaking line L2, and the overtaking path and can find out whether the mobile robot has arrived at the starting point of the second movement trajectory or the starting point of the first movement trajectory.

The method of generating an overtaking trajectory of a mobile robot according to the present invention includes the following operations.
\textcircled{1} Main travel line traveling operation S10: This operation is an operation in which a mobile robot travels on the main travel line L1 toward a destination point.
\textcircled{2} First forward obstacle detection operation S20: This operation is an operation of detecting whether an obstacle having a possibility of collision with the mobile robot is present in front of the mobile robot on the main travel line L1, and when no such obstacle is present, the main travel line traveling operation S10 is performed. When such an obstacle is present, monitoring of a front obstacle located ahead of the mobile continues until the forward waiting time elapses while the mobile robot is stopped.
\textcircled{3} Overtaking path generation operation S30: This operation is an operation of generating an overtaking path through which the mobile robot may return to the main travel line L1 via the overtaking line L2. The overtaking path includes the first movement trajectory S1 along which the mobile robot moves from the main travel line L1 to the overtaking line L2, the second movement trajectory S2 along which the mobile robot moves on the overtaking line L2, and the third movement trajectory along which the mobile robot returns from the overtaking line L2 to the main travel line L1. When an overtaking path is generated, the mobile robot moves along the first movement trajectory S1. When the overtaking path is not generated due to the presence of an obstacle, the mobile robot waits for the lane change waiting time and attempts to generate an overtaking path.
\textcircled{4} Second forward obstacle detection operation S40: This operation is an operation of detecting whether an obstacle that has a possibility of collision with the mobile robot is present on a path along which the mobile robot returns to the main travel line L1, that is, the second movement trajectory S2 and the third movement trajectory S3.
\textcircled{5} Main travel line forward movement return operation S50: This operation is an operation in which the mobile robot moves forward and returns to the main travel line L1 when no obstacle is present on the second movement trajectory S2 and the third movement trajectory S3, and subsequently, \textcircled{1} main travel line traveling operation S10 described above and subsequent operations are performed again.
\textcircled{6} Main travel line backward movement return operation S60: This operation is an operation in which, when overtaking is not possible because an obstacle is present on the first movement trajectory S1 after an overtaking path is generated or an obstacle is present on the second and third movement trajectories S2 and S3 or after the second forward obstacle detection operation, the mobile robot moves backward and returns to the starting point of the first movement trajectory S1, and subsequently, \textcircled{1} main travel line traveling operation S10 and subsequent operations are performed again.
\textcircled{7} Backward movement traveling forward/overtaking trajectory search operation S70: This operation is an operation in which, when an overtaking path is not generated until the lane change waiting time has ended in the overtaking path generation operation S30, the mobile robot moves backward on the main travel line L1 by the maximum backward search distance and generates a forward travel path or an overtaking path. When the overtaking path is generated, the starting point of the overtaking path may be set to a point moved further backward by an additional backward movement distance.

### REFERENCE NUMERALS LIST

100: main body
110: motor
120: motor driving board
130: battery
140: power supply board
150: control device
151: obstacle detection module
152: driving module
153: waiting time module
154: overtaking path generation module
155: location estimation module
160: sensor
170: MCU board
200: transport unit
300: sensor unit
310: image camera
320: LiDAR.

1. A method of generating an overtaking trajectory of a mobile robot, comprising:
a main travel line traveling operation in which a mobile robot travels along a main travel line;
a first forward obstacle detection operation of continuing front obstacle monitoring until a forward waiting time elapses while the mobile robot is stopped when an obstacle that has a possibility of collision with the mobile robot is present in front of the mobile robot on the main travel line;
an overtaking path generation operation of generating an overtaking path along which the mobile robot returns to the main travel line via an overtaking line when the obstacle is present in front of the mobile robot on the main travel line while the forward waiting time has ended;
a second forward obstacle detection operation of detecting whether an obstacle is present on a path along which the mobile robot returns to the main travel line;
a main travel line forward movement and return operation in which the mobile robot moves forward and returns to the main travel line when no obstacle is present on the path along which the mobile robot returns to the main travel line; and
a main travel line backward movement and return operation in which the mobile robot moves backward to a starting point where the mobile robot detoured from the main travel line to the overtaking line and returns to the main travel line when the obstacle is present on the path along which the mobile robot returns to the main travel line.

2. The method of claim 1, wherein the overtaking path includes a first movement trajectory along which the mobile robot moves from the main travel line to the overtaking line, a second movement trajectory along which the mobile robot moves on the overtaking line, and a third movement trajectory along which the mobile robot returns from the overtaking line to the main travel line, and
the second forward obstacle detection operation is an operation of detecting whether an obstacle is present on the second movement trajectory and the third movement trajectory.

3. The method of claim 1, further comprising a backward movement traveling forward/overtaking trajectory search operation of generating a forward travel path or an overtaking path while the mobile robot moves backward on the main travel line by a maximum backward search distance when the overtaking path is not generated until a lane change waiting time ends in the overtaking path generation operation.

4. The method of claim 3, wherein, when the overtaking path is generated, a starting point of the overtaking path is set to a point further backward by an additional backward movement distance.

5. A mobile robot that allows overtaking to be performed, comprising:
a main body;
a transport unit that moves the main body; and
a sensor unit that generates obstacle sensing data and transmits the obstacle sensing data to the main body,
wherein the main body includes a motor that generates motion necessary for movement of a robot, a motor driving board that controls the motor, a battery, a power supply board that controls the battery, and a control device that receives vision data from the sensor unit, sets a path, and generates an operation command to control the motor driving board and the power supply board, and the control device is configured to:
control the sensor unit to monitor a front obstacle until a forward waiting time elapses while the mobile robot is stopped when an obstacle that has a possibility of collision with the mobile robot is present in front of the mobile robot on a main travel line;
generate an overtaking path along which the mobile robot returns to the main travel line via an overtaking line when an obstacle is present in front of the mobile robot on the main travel line while the forward waiting time has ended; and
control the transport unit such that the mobile robot moves backward and returns to a starting point where the mobile robot detoured from the main travel line to the overtaking line when an obstacle is present on a path along which the mobile robot returns to the main travel line.
